(19) United States
(12) Patent Application Publication
(10) Pub. No.: US 2024/0316868 A1
(43) Pub. Date: Sep. 26, 2024

(54) REMOVAL TOOL AND REMOVAL SYSTEM FOR REMOVING, FROM A POWDER BED, COMPONENTS MANUFACTURED BY MEANS OF 3D PRINTING METHODS

(71) Applicant: Volkswagen Aktiengesellschaft, Wolfsburg (DE)

(72) Inventor: Shahrooz SADEGHI BORUJENI, Wolfsburg (DE)

(73) Assignee: Volkswagen Aktiengesellschaft, Wolfsburg (DE)

(21) Appl. No.: 18/731,639

(22) Filed: Jun. 3, 2024

Related U.S. Application Data
(63) Continuation of application No. PCT/EP2022/083436, filed on Nov. 28, 2022.

(30) Foreign Application Priority Data
Dec. 1, 2021 (DE) 10 2021 213 649.4

(51) Int. Cl. B29C 64/379; B25J 9/16; B25J 15/00; B33Y 40/20

(52) U.S. Cl. CPC B29C 64/379; B25J 9/1697; B25J 15/0014; B33Y 40/20

(57) ABSTRACT

A removal tool for removing, from a powder bed, components manufactured via 3D printing methods. A removal system for removing, from a powder bed, components manufactured via 3D printing methods and for cleaning the components is also provided. A removal tool for removing, from a powder bed, components manufactured via 3D printing methods is provided. Such a tool comprises a connection unit for coupling the removal tool to an at least partially automated movement device. A removal unit can be coupled to the connection unit and can be controlled via a control unit. The removal unit is movable in at least one contact support region for lifting the components from below, so that a defined removal process can be effected via the removal tool.

This nonprovisional application is a continuation of International Application No. PCT/EP2022/083436, which was filed on Nov. 28, 2022, and which claims priority to German Patent Application No. 10 2021 213 649.4, which was filed in Germany on Dec. 1, 2021, and which are both herein incorporated by reference.

### BACKGROUND OF THE INVENTION

### Field of the Invention

The invention relates to a removal tool for removing, from a powder bed, components manufactured via 3D printing methods. The invention further relates to a removal system for removing, from a powder bed, and cleaning components manufactured via 3D printing methods.

### Description of the Background Art

The technology of 3D printing in a powder bed is becoming increasingly more prevalent even for more comprehensive industrial production processes. To manufacture a greater quantity of components, for example vehicle components, at low cost, corresponding automation technologies are needed.

In particular, there is a need for semiautomated technologies, which make it possible to clean the finished components after they have been printed. In many 3D printing methods, for example in so-called binder jetting, the printed components are depowdered after the actual manufacturing process. Currently, this depowdering often takes place manually. Initial approaches to a semiautomated depowdering are currently being tested. At present, a depowdering takes place in three work steps.

The components are first roughly depowdered. This step is also known by the technical term decaking. Larger powder residues are removed from the build job. In a subsequent work step, the roughly cleaned components are usually transferred to a separate fine depowdering station. In the final step a manual final cleaning takes place in this fine depowdering station. The components are finely depowdered manually with the aid of compressed air, suction, and manual tools, for example brushes or the like.

Initial automated approaches by system manufacturers are already on the market for rough depowdering. For a complete automation, there is therefore currently a need for automated approaches for the fine depowdering and transport of the components between the individual work stations. These two requirements are preferably to be addressed, at least in part, with the aid of a technical approach. The transport of the components comprises the grasping or gripping of the components as well as the defined movement of the components to a predefined location.

Since the printed components in the powder bed-based methods are usually very fragile after the printing process, transport processes of this type must be developed with special precautionary measures. Up to now, an automated approach for the aforementioned areas have therefore proven to be difficult.

Present approaches have a number of further disadvantages. A manual fine depowdering is thus usually associated with a high exposure of employees to the production powder, for example metal powder. In addition, only an incomplete fine depowdering is usually achievable. A low productivity usually also sets in, since a manual fine depowdering is correspondingly time-intensive. The present three steps are furthermore to be viewed as time-intensive. Up to now, initial semiautomated approaches have been associated with a high degree of component rejects, since the fragile components quickly become damaged.

A few examples from the prior art are described below, which, in the broadest sense, deal with the aforementioned problems.

A gripper and an unloading station are apparent as known from the publication DE 10 2019 008 281 B3. In particular, a gripper is disclosed, which includes a gripper flange, which is designed for fastening the gripper to a movement device. The gripper also comprises a hollow body connected to the gripper flange, which has at least one distribution opening and at least one closeable receiving opening, which is preferably different than the distribution opening. The gripper furthermore comprises a closing component, which is supported in an automatically movable manner between a closed position closing the receiving opening and an open position releasing the receiving opening, and which is designed to close the receiving opening when the hollow body of the gripper surrounds a gripping object embedded in a bulk material bed. An associated unloading station is also disclosed.

Systems and methods for printing a three-dimensional object are also apparent as known from the publication WO 2020/210433 A1, which corresponds to US 2022/0193980. Systems and methods for printing a three-dimensional object are described. A method may comprise providing a support matrix having a base component and depositing an ink with the base component, a catalyst, and a cross-linker into the support matrix. The ink may be deposited into the support matrix in a predetermined pattern, which is effective for forming a multiplicity of ink layers. The support matrix supports the multiple layers of the ink, and the sections of the support matrix are arranged between two layers of the ink when the multiple layers are formed in the support matrix. The method may also comprise solidifying or curing the ink deposited into the support matrix and also the portions of the carrier matrix deposited between the ink layers for the purpose of forming the three-dimensional object.

Systems and methods for removing a powder are apparent as known from the publication WO 2019/237007, which corresponds to US 2019/374983. A powder removal system comprises a multiplicity of tubes having ends situated upstream and downstream, a manifold fluidically coupled with the tubes, and a compressed air supply fluidically coupled with the manifold, which supplies compressed air to the tubes via the manifold. The downstream ends of the tubes are inserted into a multiplicity of channels, which are partially filled with powder.

A method for optimizing an object manufactured via 3D printing methods is apparent as known from the publication DE 10 2018 127 950, which is incorporated herein by reference. A method for manufacturing a tool assembly is furthermore apparent as known from this publication In particular, this publication relates to a method for optimizing an object manufactured via 3D printing methods as well as a method for manufacturing a tool assembly for use in the method for optimizing an object manufactured via 3D printing methods. It is provided that a method for optimizing an object manufactured via 3D printing methods is made available. A method of this type comprises the following steps: Providing an object manufactured via 3D printing methods and based on a first data set, clamping and holding the object with the aid of a tool assembly, carrying out at least one treatment step on the clamped object, so that a depowdering process of the object may be implemented, the tool assembly being manufactured via a 3D printing method and via a second data set, the second data set being at least partially identical to the first data set, so that a form fit may be at least partially implemented between the tool assembly and the object during the clamping and holding. A method for manufacturing a tool assembly for use in the method for optimizing an object manufactured via 3D printing methods is also provided.

Methods for the additive manufacturing of at least two components are also apparent as known from the publication DE 10 2018 133 292. Known herefrom are methods for the additive manufacturing of at least two components, in particular vehicle components, via successive, layer-by-layer, selective solidification of layers of an, in particular, powdery build material using at least one energy beam, at least one container receiving at least two components in its interior being manufactured for forming a handling group, which may be jointly handled and comprises the at last two components, by successively and selectively solidifying layers of the build material layer by layer and, after the manufacturing of the at least two components, in particular after removing non-solidified build material, at least one, in particular all, of the at least two components being removed from the container for separating the handling group, at least in sections.

### SUMMARY OF THE INVENTION

It is therefore an object of the invention to provide a removal tool and a removal system, which at least partially overcome the aforementioned disadvantages.

In an example of the invention, it is provided that a removal tool is provided for removing, from a powder bed, components manufactured via 3D printing methods. A removal tool of this type can comprise a connection unit for coupling the removal tool to an at least partially automated movement device, a removal unit, which may be coupled to this connection unit and controlled via a tool-internal or tool-external control unit, for removing, from a powder bed, components manufactured via 3D printing methods. The removal unit is designed to be at least partially movable in at least one contact support region, which faces the components to be removed during a removal process, for lifting the components from below, so that a defined removal process may be effected via the removal tool.

In this way, it is possible to provide a removal tool which at least partially overcomes the aforementioned disadvantages. In this connection, the process of lifting the components includes, in particular, in that the components are lifted from below via the described removal tool. In other words, the described removal tool is designed to remove, from the powder bed, the components to be removed in that this removal tool is to be first place under the components for the purpose of subsequently lifting them in a defined manner.

In this respect, the removal tool is designed to lift, from below, the components to be removed during a removal process, so that these components are then situated there during the removal process, the contact support region being designed to be at least partially movable, so that a defined removal process may be effected via the removal tool. The ability to move causes the components to remain in a defined position on the tool while they are being transported.

Instead of gripping the components from above or the side via a gripping device, as is otherwise customary, the provided removal unit is to be first positioned under the components to be removed to then effect a targeted removal process from below. The components are situated on the at least one contact support region and, due to the movable components, are then able to be fixed there in a defined manner during the removal process.

Depending on the size of the components to be removed, a contact support region of this type may have a corresponding surface, on which the components are situated, to then be lifted from below in a defined manner, the movable portions of the removal unit additionally being able to fix the situated components.

Due to the contact support region designed to be at least partially movable for lifting the components, it is possible to effect a sensitive removal operation. The components may thus be removed without resulting in undesirable damage. The mobility causes the components to remain in a defined position on the tool while they are being transported.

Smaller components may thus also be removed in a defined manner, and no undesirable damage occurs. Since the removal tool lifts the components, in particular lifts them from below in a defined manner, particular outer contact surfaces of the printed components, which may also be referred to as green bodies, are easily accessible from all sides, for example, to carry out initial fine depowdering steps during the transport process. Due to the movably designed contact support region of the removal tool, the components are placed on the tool in a stable manner in such a way that, for example, an application of compressed air is possible during the removal process. Since the described removal tool may also be coupled to an at least partially automated movement device via the connection unit, automated removal processes may also be carried out. The movably designed contact support regions ensure that a removal process as well as an initial fine depowdering may be effected during transport.

A removal system can be made available for removing, from a powder bed, as well as cleaning components manufactured via 2D printing methods. A removal system of this type comprises at least one removal tool according to the invention. The aforementioned advantages also apply, to the extent transferable, to the described removal system.

The different examples of the invention mentioned may be advantageously combined with each other.

The removal tool can have at least two contact support regions designed to be movable separately from each other.

In this way, the components to be removed may be lifted from below in an even more defined manner, so that a particularly gentle removal process may be carried out. Even more complex geometric shapes of underbody regions of components to be removed may thus be taken into account via the described removal tool. In other word, lifting processes of the components to be removed may be carried out in a particularly defined manner, due to the two contact support regions, taking into account a particular heterogeneous component geometry in the outer base region of the components, so that damage is avoidable during the removal.

The at least one contact support region can be essentially designed as a finger element protruding from the removal tool. It is conceivable that the receipt of the components may be carried out accordingly by only one finger element suitable for this purpose, which has a sufficient width. If the contact support regions are narrower than the components to be removed, it is conceivable that two or three finger elements of this type are provided accordingly, so that the component rests upon these two or three finger elements during the removal process.

The at least one contact support region can have an essentially tapered end region in a region facing the powder bed, so that the removal unit may dip into the powder bed in a defined manner. The tapered end regions may be advantageously used, for example, when the production material in the powder bed is present in compact form at least in areas, so that these solidified portions must be mechanically loosened accordingly. The end regions permit a defined sequence of movements on the described removal tool in the powder bed. In this way, the removal tool may dip into the powder bed in a targeted manner, so that it may be placed in a targeted manner under the particular component to be removed.

The tool-internal or tool-external control unit can comprise a movement program, which is designed to at least partially require defined removal processes, depending on design data of the components. In this way, the described removal tool may be inserted into the powder bed relative to the components to be removed in an even more targeted manner in such a way that a particularly gentle removal process may be carried out.

The system can further comprise at least one camera device. Comprehensive control possibilities based on image recordings provided by a camera device of this type may thus be carried out.

The system also can comprise at least one compressed air nozzle device and/or a vibration application device. Depowdering processes, in particular fine depowdering processes, may thus be carried out even during the removal process.

The system can further comprise a control unit, which is designed to control at least one removal tool, the at least one compressed air nozzle device, and the vibration application device, in least partial dependence on each other, so that a removal process and a cleaning process may be carried out. The aforementioned advantages may be even better achieved thereby.

The control unit can furthermore be designed to control the removal process and cleaning process at least partially via image recordings provided by the camera device.

A defined placement process of the described removal tools may be carried out even better thereby. In addition, fine depowdering processes may thus be carried out in an even more targeted manner in parallel during a removal process, so that a cost-effective automation is possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a removal system for removing, from a powder bed, and cleaning components manufactured via 3D printing methods;

FIG. 2 shows a further schematic representation of a removal system for removing, from a powder bed, and cleaning components manufactured via 3D printing methods, according to FIG. 1; and

FIG. 3 shows a further schematic representation of a removal system for removing, from a powder bed, and cleaning components manufactured via 3D printing methods, according to FIG. 1.

### DETAILED DESCRIPTION

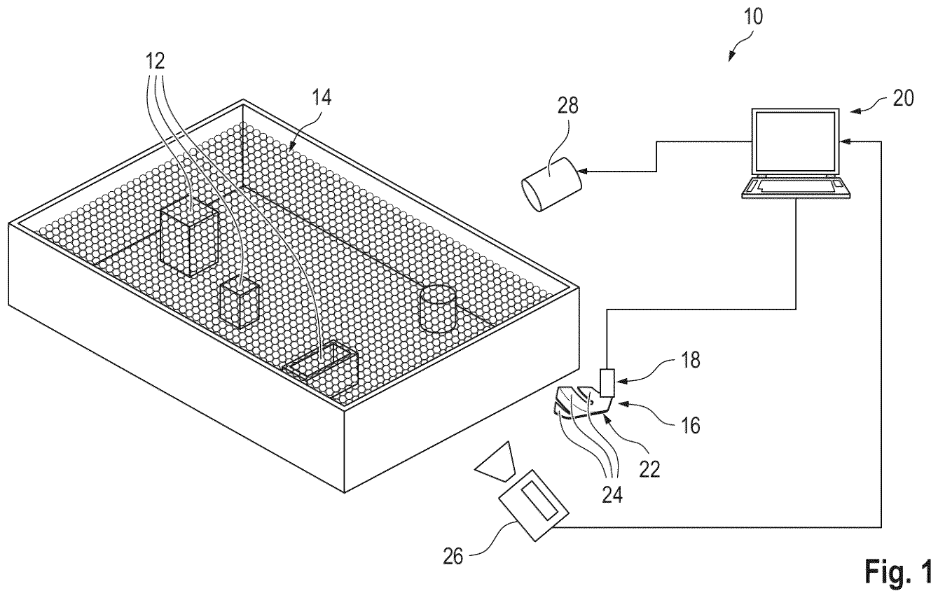

FIG. 1 shows a schematic representation of a removal system 10 for removing, from a powder bed 14, and cleaning components 12 manufactured via 3D printing methods.

Removal system 10 for removing, from powder bed 14, and cleaning components 12 manufactured via 3D printing methods is illustrated with a removal tool 16.

Illustrated removal tool 16 for removing, from powder bed 14, components 12 manufactured via 3D printing comprises a connection unit 18 for coupling removal tool 16 to an at least partially automated movement device. A movement device of this type may be, for example, an articulated robot, which is typically used in industrial manufacturing plants.

A removal unit 22 is also shown, which may be coupled to this connection unit 18 and controlled via a tool-internal or tool-external control unit 20, for removing, from a powder bed 14, components 12 manufactured via 3D printing methods.

Illustrated removal tool 22 has contact support regions 24. During a removal process, these contact support regions 24 face components 12 to be removed. In other words, components 12 to be removed are lifted, in that contact support regions 24 are brought into contact with a lower region of components 12, so that a defined removal process may be effected via removal tool 16.

Three contact support regions 24 are provided in this example. Two narrower contact support regions 24 are provided on particular outer sides, and a wide contact support region 24 is provided in the center. Illustrated contact support regions 24 are essentially designed as finger elements protruding from removal tool 16. In a design variant, it is conceivable that only one contact support region 24 is provided.

Removal tool 16 is shown, coupled with illustrated control unit 20.

Removal system 10 furthermore includes a camera device 26 and a compressed air nozzle device 28. it is conceivable that more than one camera device 26 and more than one compressed air nozzle device 28 are provided in each case.

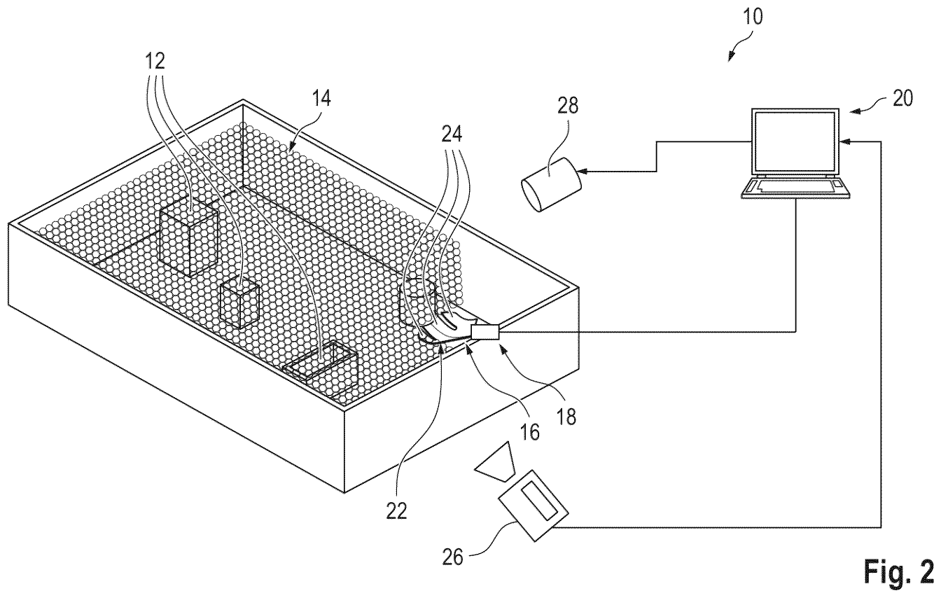

FIG. 2 shows a further schematic representation of a removal system 10 for removing, from a powder bed 14, and cleaning components 12 manufactured via 3D printing methods, according to FIG. 1. The same reference numerals as in FIG. 1 apply, so that they are not again introduced here. In particular, the way in which removal tool 16 dips into powder bed 14 and is placed relative to the position of a component 12 for the purpose of removal is illustrated.

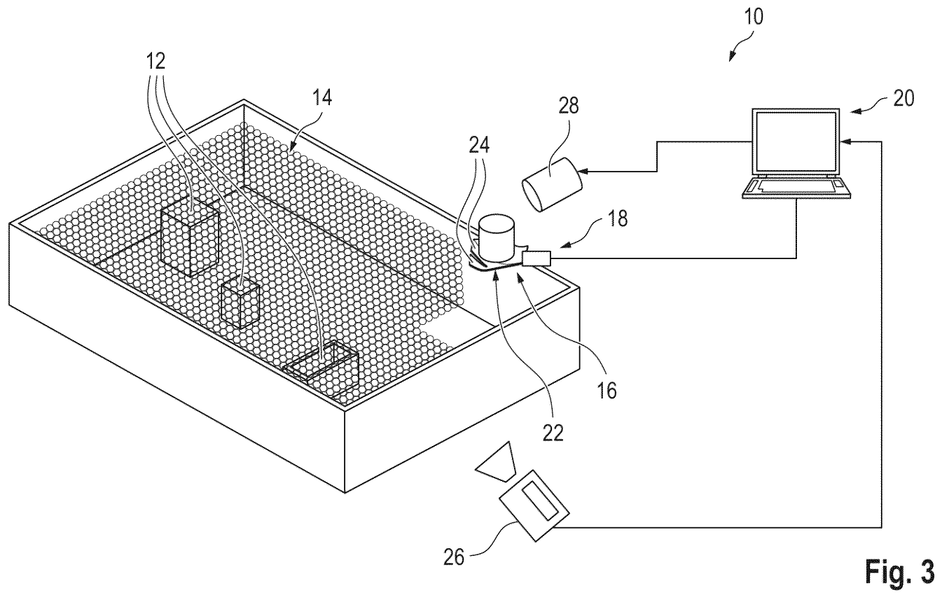

FIG. 3 shows a further schematic representation of a removal system 10 for removing, from a powder bed 14, and cleaning components 12 manufactured via 3D printing methods, according to FIG. 1. The same reference numerals as in the preceding figures apply, so that they are not again introduced here. In this representation, component 12 is already situated on contact support regions 24 and is lifted accordingly out of powder bed 14.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A removal tool to remove from a powder bed at least one component manufactured via 3D printing methods, the removal tool comprising:
a connection unit to couple the removal tool to an at least partially automated movement device;
a removal unit adapted to be coupled to the connection unit and controlled via a tool-internal or tool-external control unit, for removing, from the powder bed, the at least one component manufactured via 3D printing methods,
wherein the removal unit is at least partially movable in at least one contact support region facing the component to be removed during a removal process for the purpose of lifting the component from below so that a defined removal process is effected via the removal tool.

2. The removal tool according to claim 1, wherein the removal tool includes at least two contact support regions designed to be movable separately from each other.

3. The removal tool according to claim 1, wherein the at least one contact support region is a finger element protruding from the removal tool.

4. The removal tool according to claim 1, wherein the at least one contact support region has an essentially tapered end region in a region facing the powder bed so that the removal unit dips into the powder bed in a defined manner.

5. The removal tool according to claim 1, wherein the tool-internal or tool-external control unit comprises a movement program, which is designed to at least partially require defined removal processes, depending on design data of the components.

6. A removal system for removing, from a powder bed, and cleaning at least one component manufactured via 3D printing methods, the system comprising at least one removal tool according to claim 1.

7. The removal system according to claim 6, wherein the system further comprises at least one camera device.

8. The removal system according to claim 6, wherein the system further comprises at least one compressed air nozzle device and/or a vibration application device.

9. The removal system according to claim 6, wherein the system further comprises a control unit, which is designed to control at least one removal tool, the at least one compressed air nozzle device, and the vibration application device, at least partially depending on each other, so that a removal process and a cleaning process may be carried out.

10. The removal system according to claim 6, wherein the control unit is further designed to control the removal process and cleaning process at least partially via image recordings provided by the camera device.
